(19) United States
(12) Patent Application Publication
(10) Pub. No.: US 2005/0062587 A1
(43) Pub. Date: Mar. 24, 2005

(54) Method and structure of a substrate with built-in via hole resistors

(76) Inventors: Wei-Chun Yang, Taipei City (TW); Chien Wei Chang, Taoyuan Hsien (TW)

Correspondence Address: BIRCH STEWART KOLASCH & BIRCH, PO BOX 747, FALLS CHURCH, VA, 22040-0747, US

(21) Appl. No.: 10/668,999

(22) Filed: Sep. 24, 2003

(51) Int. Cl. H01C 1/012

(52) U.S. Cl. 338/311

(57) ABSTRACT

A structure and a method of a substrate with built-in via hole resistors are disclosed. The substrate structure includes a core layer made of insulating material and a plurality of via holes for filling with polymer thick film resistor. After the via holes are filled with PTFR, a solder ball or a pad is formed on both ends of the via hole to provide electrical conductivity.

### FIELD OF THE INVENTION

This invention relates to a method and a structure of a substrate with built-in via hole resistors and, more particularly, to a method a structure of a substrate with via hole filled with polymer thick film resistor (PTFR) to form built-in resistors.

### BACKGROUND OF THE INVENTION

U.S. Pat. No. 6,256,866, dated Jul. 10, 2001, disclosed a method for manufacturing a polymer thick film printed circuit board (PCB).

The thick film resistors are used in electronic circuits to provide a wide range of resistance. The thick film resistors are manufactured by printing, such as screen-printing, a layer of thick film glue or paste on a substrate. The substrate can be a printed wiring board (PWB), flexible circuits, and ceramics or silicon substrate. The thick film paste-resistors used on the organic printed wire board are usually made of conductive material with additive to improve the resistance, such as organic binder on an organic vehicle. After the printing step, the thick film paste is heated and dried to be transformed into a suitable thin film attached to the substrate. If polymer thick film paste is used, such as organic binder, which is a polymer matrix material, the heating step is able to remove the organic vehicle, and repair the polymer matrix material.

The resistance of the thick film resistors depends on the manufacturing precision, the stability of the resistant material, and the stability of the resistor terminals. The x-axis and the y-axis (the thickness and the width of the resistor) of a rectangular polymer thick film resistor (PTFR) are determined by the resistor termination pattern. The conventional screen printing uses a template with small gaps of the shape of resistors. The template, used as a screening mask, is placed over the substrate where the resistors are to be formed. The screening mask is then loaded with a polymer thick film resistor paste, and a squeegee blade is used to sweep over the screening mask to push the paste through the gaps and falls on the substrate.

The copper terminations are usually formed with the following step: before the paste is deposited, a subtractive etching metal plating, or a subtractive panel plating is added, and its edge definition determines the electrical length “y”.

Compared to the electrical deposition, the screen printing is a rather rough process. Therefore, the scales of polymer thick film resistors related with the screen printing are usually larger than a millimeter, with a dimensional tolerance lower bound larger than ±10%. The electrical length “y” of the polymer thick film resistors related with the screen printing can form a suitable termination. The “x” and the “y” of the polymer thick film resistors depend on the gaps of the screening mask.

Another reason that the morphology of the resistors is hard to control is that the stability of the resistor paste used in the printing. Most of the resistors are defined by the patterned copper, whose interconnection is limited to the thickness of 10-35 micrometers. This interconnection interferes the squeegee step over the screening mask, so that the printing is imperfect and the paste deposition is not uniform. Therefore, the difference of the resistance of the polymer thick film resistors can be as high as ±20%. It is usually necessary to rectify with the laser trimming, which is usually prohibitively expensive.

FIG. 1 shows a cross-sectional view of a substrate made with screening printing polymer thick film resistors. As shown in FIG. 1, its structure comprises a core layer 10 and a plurality of via holes 12. The core layer 10 is made of insulating material, such as a BT resin. The polymer thick film resistor 102 is placed horizontally on both sides of the core layer 10 according to the number of the squares in a unit area. A copper layer can be added on the topside and the bottom side of the core layer 10 to form a first copper layer 14, and a second copper layer 16.

There are two ways to form the via holes 12. One is to penetrate the first copper layer and the second copper layer from the top or the bottom side, and stops when reaching the PTFR 102 on both sides of the core layer 10. The inner wall of the via holes 12 is then electroplated with a layer of metal (not shown in the figure) to form an electric conduction structure for the resistor with the intended resistance. The other method to manufacture via holes is to penetrate the entire core layer 10. The inner wall of the via holes is then electroplated with a metal layer to form a conductive circuit without any resistance. The via holes 12 that penetrate the core layer 10 are later filled with polymer thick film resistor, and formed a solder ball on both ends for conductivity. The solder ball can be made of tin, or tin alloy.

The method of using polymer thick film resistor in the inner layer usually relies on the surface resistance of a unit square to adjust the target resistance. It has the drawback of using a large area when a higher aspect ratio is required, which may cause high deviation from the resistance. In addition, the thin and long resistor lines will suffer the parasitical inductance, a phenomenon that the designers have always tried to eliminate.

### SUMMARY OF THE INVENTION

The first objective of the present invention is to provide a new routing structure and technique by using via holes of different aspect ratios, so that the designers have more flexibility to adjust the resistance of the built-in resistors.

The second objective is to take advantage of the flexibility of the routing so that the overall area of the substrate can be reduced.

The third objective of the present invention is to reduce the parasitical inductance at high frequency by using polymer thick film resistors in the via hole.

The present invention, a substrate with built-in via hole resistors employs the via holes widely used on the substrates, combined with a also widely used polymer thick film resistor, to form the sites for the built-in resistors. The via holes are filled with polymer thick film resistor, and a solder ball or pad is formed on both ends of the via holes to provide electrical conductivity.

FIG. 2 shows a cross-sectional view of the present invention. The structure of the present invention, a substrate with built-in via hole resistors, comprises a core layer 20 and a plurality of via holes 22. The core layer 20 is made of an insulating material, such as a BT resin. In addition, the topside of the core layer 10 can be covered with a copper layer (not shown). The via holes 22 penetrate the core layer 20, and will be filled with polymer thick film resistor. After the PTFR fills the via holes 22, a solder ball 24 is formed on both ends of the via holes 22 for electrical conductivity. The solder ball 24 can be made of tin, or tin alloy.

These and other objects, features and advantages of the invention will be apparent to those skilled in the art, from a reading of the following brief description of the drawings, the detailed description of the preferred embodiment, and the appended claims.

### BRIEF DESCRIPTION OF THE DRAWINGS

FIG. 1 shows a cross-sectional view of a substrate manufactured with prior arts using printing polymer thick film resistor.

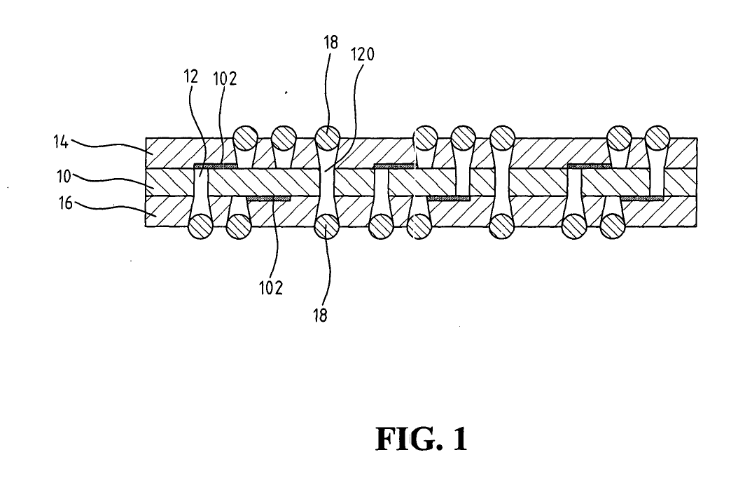

FIG. 2 shows a cross-sectional view of the present invention.

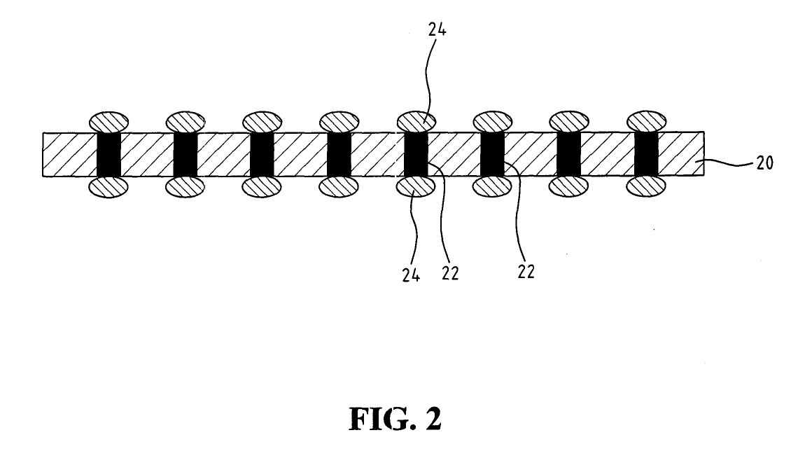

FIG. 3 shows a 3-dimensional diagram of via holes of the present invention.

FIG. 4 shows the manufacture process of the present invention.

### DETAILED DESCRIPTION OF THE INVENTION

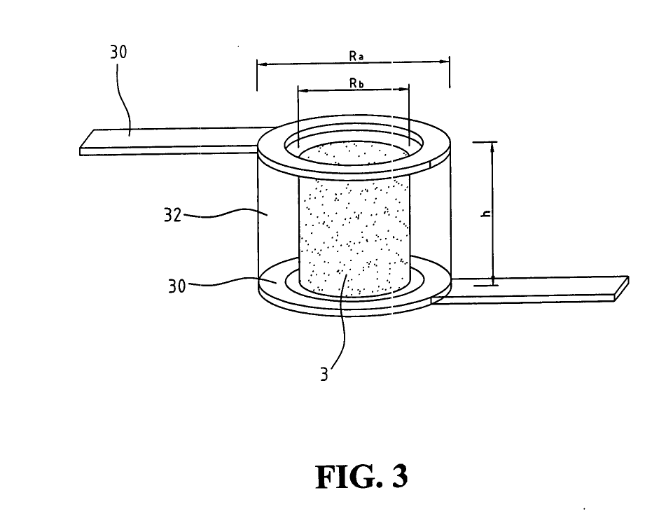

FIG. 3 shows a 3-dimensional view of the via holes of the present invention. As shown in FIG. 3, Ra is the target diameter of the via hole 3, Rb is the actual diameter of the via hole, and h is the thickness of the copper foil. The top side and the bottom side of the via hole 3 are both copper foil 30. The outer side of the via hole 3 is a film 32. In the present invention, the resistance can be adjusted by varying the ratio of the diameter and length so that the amount of the PTFR in the via holes also varies. For example, if the via hole 3 with a diameter-length ratio 1 filled with PTFR has a resistance of 100 ohm, a via hole 3 with a diameter-length ratio 12 filled with PTFR will have a resistance of 1200 ohm.

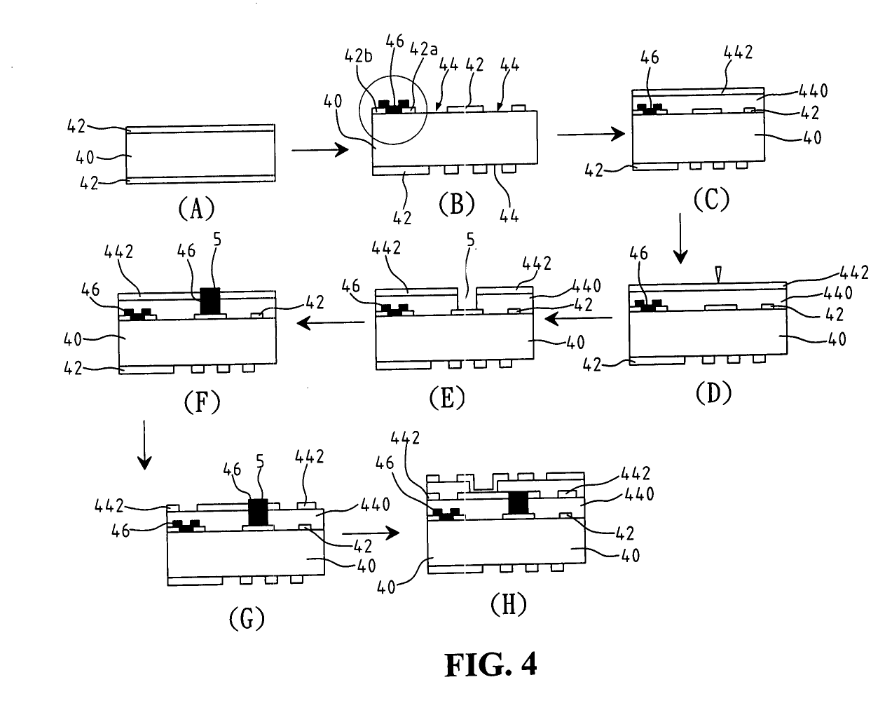

FIG. 4 shows a manufacturing process of the present invention. The process comprises the following steps:
(a) providing a substrate with metal foils on both sides, as shown in FIG. 4A, wherein the substrate 40 is in the middle, and both top side and bottom side covered with a copper foil 42;
(b) performing exposure, print and etching to the copper foil 42 on the top side of the substrate 40, the etched copper foil 42 will expose the substrate 40 where the via holes 44 will be drilled;
An extra step can be executed between step (b) and (c) to fill the PTFR between the two neighboring pads 42a and 42b after the etching of copper foil 42. This step is a prior art, as shown in the black area circled in a dash line in FIG. 4B. It forms an electrical path with a target resistance.
(c) laminating the copper foil and the film on the top side of the substrate 40, as shown in FIG. 4C, a film 440 and a copper foil 442 is pressed onto the metal foil 42 on the top side of the substrate 40;
(d) drilling via holes on the copper foil and the film, as shown in FIG. 4D, where the arrow indicates the location of the via holes, and FIG. 4E shows after the drilling, a via hole 5 is formed;
(e) filling PTFR 46 into the via hole 5, as shown in FIG. 4F, the black area is the PTFR 46. This step can be completed with a stencil printing, or screening printing;
(f) manufacturing a conductive path, as shown in FIG. 4G, the topmost copper foil is etched to form individual conductive path; and
(g) repeating steps (c), (d), and (f), as shown in FIG. 4H to manufacture the next conductive path.

Compared to the prior arts, the present invention has the following advantages:
(1) The error of the resistance can be less than 10% as the amount of the PTFR is limited by the morphology of the via holes during the step of filling the PTFR in the via holes.
(2) The number of the via holes increases as the substrate gets more complicated. With prior arts, this means that the areas that can be used for built-in resistors are reduced, and sometimes the design will need extra routing, which, in turn, will increase the parasitical inductance and the manufacturing difficulties. By using the via holes as the built-in resistors will avoid this type of problem.
(3) The filling of PTFR into the via holes can eliminate the step of lamination in prior arts, therefore, also avoids the error, which can be as high as 5%.
(4) By varying the number of the via holes, the geometrical ratio and the resistance of the filling PTFR, the present invention can be used for distributed components in a high frequency system.

While the invention has been described in connection with what is presently considered to the most practical and preferred embodiment, it is to be understood that the invention is not to be limited to the disclosed embodiment, but on the contrary, is intended to cover various modifications and equivalent arrangement included within the spirit and scope of the appended claims.

1. A substrate structure with built-in via hole resistors, comprising:
a core layer, made of an insulating material; and
a plurality of via holes, penetrating the core layer and to be filled with polymer thick film resistor, and a solder ball or a conductive pad being formed on both ends of the via hole to provide electrical conductivity.

2. The substrate structure as claimed in claim 1, wherein the core layer is a preprag.

3. The substrate structure as claimed in claim 2, wherein the core layer further comprises a copper foil on top of the film layer.

4. The substrate structure as claimed in claim 1, wherein the solder ball is made of tin, or tin alloy.

5. The substrate structure as claimed in claim 1, wherein the conductive pad is made of metal or metal alloy or a conductive paste.

6. The substrate structure as claimed in claim 1, wherein the resistance of the via hole resistor is adjusted by varying the diameter-length ratio of the via hole, which, in turn, varying the amount of the PTFR filled.

7. The substrate structure as claimed in claim 1, wherein the via holes is filled with one or more via hole PTFR to reduce the parasitical inductance generated by PTFR with a large diameter-length ratio.

8. The substrate structure as claimed in claim 7, wherein the equivalent circuit of the reducing parasitical inductance has the effect of distributed components that is used in a high frequency system to adjust the capacitance and inductance.

9. A method for manufacturing a substrate with built-in via hole resistors, the method comprising the following steps:
(a) providing a substrate with metal foils on both sides;
(b) performing exposure, print and etching to the metal foil on the top side of the substrate to form the locations on the substrate where the via holes will be drilled;
(c) laminating a copper foil and a film on the top side of the substrate;
(d) drilling via holes on the copper foil and the film with laser;
(e) filling PTFR into the via holes;
(f) manufacturing a conductive path; and
(g) repeating steps (c), (d), and (f), to manufacture the next layer of the board.

10. The method as claimed in claim 9, wherein step (e) is a roller printing step.

11. The method as claimed in claim 9, wherein step (e) is a screen printing step.

12. The method as claimed in claim 9, wherein step (e) is a stencil printing step.

13. The method as claimed in claim 9, wherein step (e) is a dispenser printing step.

14. The method as claimed in claim 9, wherein step (e) is a ink-jet printing step.

15. The method as claimed in claim 9, wherein a step of filling PTFR between two neighboring pads is after step (b).
